(19) United States
(12) Patent Application Publication
(10) Pub. No.: US 2026/0269900 A1
(43) Pub. Date: Sep. 10, 2026

(54) METHOD, DEVICE AND COMPUTER PROGRAM PRODUCT FOR DETERMINING STATE CHANGE OF OBJECT

(71) Applicant: TP-Link Systems Inc., IRVINE, CA (US)

(72) Inventor: Haozheng LI, Chengdu (CN)

(73) Assignee: TP-Link Systems Inc., IRVINE, CA (US)

(21) Appl. No.: 19/073,182

(22) Filed: Mar. 7, 2025

(51) Int. Cl. H04B 7/06; H04B 17/309

(52) U.S. Cl. CPC H04B 7/0626; H04B 17/309

(57) ABSTRACT

This disclosure provides a method, device and a computer program product for determining a state change of an object. The method may include: determining change degrees of each motion feature of a plurality of motion features over time based on channel state information; and determining that the object undergoes the state change at a first time point, in response to a change degree of each of at least one motion feature of the plurality of the motion features at the first time point being greater than a threshold associated with each of the at least one motion feature.

### TECHNICAL FIELD

The present disclosure relates to the field of Wi-Fi sensing, more specifically, to a method, device and a computer program product for determining a state change of an object.

### BACKGROUND

With the development of Wi-Fi technology, it has been widely applied in homes, offices and public areas because of its advantages of fast transmission speed, low cost and simple installation. Wi-Fi sensing is a technology that leverages channel state information extracted from Wi-Fi signals to detect and analyze the presence, movement, and actions of objects or people within a propagation range of the Wi-Fi signals. The principal that Wi-Fi sensing based on is that the movement of the object, for example people, in the environment disturbs the channel state and changes the channel state information. By obtaining the change of channel state information through appropriate signal processing algorithm, the presence, movement, and actions of the object can be sensed.

Motion detection technology can detect motion behavior of people, including both (1) stationary and motion detection (that is, detecting whether someone is moving or making actions in the environment) and (2) motion segmentation (that is, whether the motion mode of the object has changed, such as changing from walking to jumping and from standing up to falling).

### SUMMARY

The present disclosure provides techniques for determining a state change of an object efficiently. In particular, the present disclosure provides a method, device and a computer program product for determining a state change of an object. Through the techniques described herein, whether the object undergoes the state change at a certain time point may be determined based on change degrees of a plurality of motion features. As a plurality of motion features are taken into consideration, a combined and more comprehensive determination may be made as compared to the determination based on a single motion feature, improving the accuracy and adaptability of the determination. Besides, the change degrees of a plurality of motion features, instead of instantaneous values of a motion feature, are taken into consideration, leading to less dependency of the determination on environment, further improving the accuracy and adaptability of the determination.

According to an aspect of the present disclosure, there is provided a method for determining a state change of an object. The method comprises: determining change degrees of each motion feature of a plurality of motion features over time based on channel state information; and determining that the object undergoes the state change at a first time point, in response to a change degree of each of at least one motion feature of the plurality of the motion features at the first time point being greater than a threshold associated with each of the at least one motion feature.

In some embodiments, each of the plurality of the motion features can indicate an influence of the object on one or more wireless channels.

In some embodiments, the determining the change degrees of each motion feature of the plurality of the motion features over time based on the channel state information comprises, for a first motion feature among the plurality of the motion features: preprocessing the channel state information to obtain preprocessed data, wherein the preprocessing comprises at least one of a noise reduction, an outlier elimination, a data calibration, an antenna selection or a subcarrier selection; and determining change degrees of the first motion feature over time based on the preprocessed data.

In some embodiments, the first motion feature comprises one of: statistical data of phase data derived from the preprocessed data; statistical data of amplitude data derived from the preprocessed data; and spectrum information derived from the preprocessed data.

In some embodiments, a change degree of a first motion feature of the plurality of the motion features at a time point comprises a first amount of change of the first motion feature between a first time period before and a second time period after the time point; and a change degree of a second motion feature of the plurality of the motion features at the time point comprises a second amount of change of the second motion feature between a third time period before and a fourth time period after the time point, wherein each two of the first time period, the second time period, the third time period and the fourth time period may be the same or different from each other in duration.

In some embodiments, the determining that the object undergoes the state change at the first time point, in response to the change degree of each of the at least one motion feature of the plurality of the motion features at the first time point being greater than the threshold associated with each of the at least one motion feature comprises: determining that the object undergoes the state change at the first time point, in response to the change degree of a first motion feature of the plurality of the motion features at the first time point being greater than a threshold associated with the first motion feature. The method further comprises, in response to determining that the object undergoes the state change: determining that the object undergoes another state change at a second time point after the first time point, in response to change degrees of one or more motion features of the plurality of the motion features other than the first motion feature at the second time point being greater than one or more thresholds associated with the one or more motion features.

In some embodiments, the state change comprises a transition from a stationary to a motion state, a transition from the motion state to the stationary state, or a transition from a first mode of motion to a second mode of motion.

In some embodiments, the channel state information may be obtained from Wi-Fi signals.

According to another aspect of the present disclosure, there is provided a device for determining a state change of an object. The device comprises one or more processors; a memory coupled to at least one of the one or more processors; and a set of computer program instructions stored in the memory. The set of computer program instructions, in response to being executed by at least one of the one or more processors, can perform actions of: determining change degrees of each motion feature of a plurality of motion features over time based on channel state information; and determining that the object undergoes the state change at a first time point, in response to a change degree of each of at least one motion feature of the plurality of the motion features at the first time point being greater than a threshold associated with each of the at least one motion feature.

In some embodiments, each of the plurality of motion the features can indicate an influence of the object on one or more wireless channels.

In some embodiments, the determining the change degrees of each motion feature of the plurality of the motion features over time based on the channel state information comprises, for a first motion feature among the plurality of the motion features: preprocessing the channel state information to obtain preprocessed data, wherein the preprocessing comprises at least one of a noise reduction, an outlier elimination, a data calibration, an antenna selection or a subcarrier selection; and determining change degrees of the first motion feature over time based on the preprocessed data.

In some embodiments, the first motion feature comprises one of: statistical data of phase data derived from the preprocessed data; statistical data of amplitude data derived from the preprocessed data; and spectrum information derived from the preprocessed data.

In some embodiments, a change degree of a first motion feature of the plurality of the motion features at a time point comprises a first amount of change of the first motion feature between a first time period before and a second time period after the time point; and a change degree of a second motion feature of the plurality of the motion features at the time point comprises a second amount of change of the second motion feature between a third time period before and a fourth time period after the time point, wherein each two of the first time period, the second time period, the third time period and the fourth time period may be the same or different from each other in duration.

In some embodiments, the determining that the object undergoes the state change at the first time point, in response to the change degree of each of the at least one motion feature of the plurality of the motion features at the first time point being greater than the threshold associated with each of the at least one motion feature comprises: determining that the object undergoes the state change at the first time point, in response to the change degree of a first motion feature of the plurality of the motion features at the first time point being greater than a threshold associated with the first motion feature. The set of computer program instructions, in response to being executed by at least one of the one or more processors, can further perform actions of, in response to determining that the object undergoes the state change: determining that the object undergoes another state change at a second time point after the first time point, in response to change degrees of one or more motion features of the plurality of the motion features other than the first motion feature at the second time point being greater than one or more thresholds associated with the one or more motion features.

In some embodiments, the state change comprises a transition from a stationary to a motion state, a transition from the motion state to the stationary state, or a transition from a first mode of motion to a second mode of motion.

In some embodiments, the channel state information may be obtained from Wi-Fi signals.

According to yet another aspect of the present disclosure, there is provided a computer program product for determining a state change of an object. The computer program product comprises a non-transitory computer readable storage medium having program instructions embodied therewith. The program instructions, in response to being executed by a processor, can cause the processor to: determine change degrees of each motion feature of a plurality of motion features over time based on channel state information; and determine that the object undergoes the state change at a first time point, in response to a change degree of each of at least one motion feature of the plurality of the motion features at the first time point being greater than a threshold associated with each of the at least one motion feature.

In some embodiments, each of the plurality of the motion features can indicate an influence of the object on one or more wireless channels.

In some embodiments, the determining the change degrees of each motion feature of the plurality of the motion features over time based on the channel state information comprises, for a first motion feature among the plurality of the motion features: preprocessing the channel state information to obtain preprocessed data, wherein the preprocessing comprises at least one of a noise reduction, an outlier elimination, a data calibration, an antenna selection or a subcarrier selection; and determining change degrees of the first motion feature over time based on the preprocessed data.

In some embodiments, the first motion feature comprises one of: statistical data of phase data derived from the preprocessed data; statistical data of amplitude data derived from the preprocessed data; and spectrum information derived from the preprocessed data.

In some embodiments, a change degree of a first motion feature of the plurality of the motion features at a time point comprises a first amount of change of the first motion feature between a first time period before and a second time period after the time point; and a change degree of a second motion feature of the plurality of the motion features at the time point comprises a second amount of change of the second motion feature between a third time period before and a fourth time period after the time point, wherein each two of the first time period, the second time period, the third time period and the fourth time period may be the same or different from each other in duration.

In some embodiments, the determining that the object undergoes the state change at the first time point, in response to the change degree of each of the at least one motion feature of the plurality of the motion features at the first time point being greater than the threshold associated with each of the at least one motion feature comprises: determining that the object undergoes the state change at the first time point, in response to the change degree of a first motion feature of the plurality of the motion features at the first time point being greater than a threshold associated with the first motion feature. The program instructions can further cause the processor to, in response to determining that the object undergoes the state change: determining that the object undergoes another state change at a second time point after the first time point, in response to change degrees of one or more motion features of the plurality of the motion features other than the first motion feature at the second time point being greater than one or more thresholds associated with the one or more motion features.

In some embodiments, the state change comprises a transition from a stationary to a motion state, a transition from the motion state to the stationary state, or a transition from a first mode of motion to a second mode of motion.

In some embodiments, the channel state information may be obtained from Wi-Fi signals.

At least based on the above embodiments of the present disclosure, whether the object undergoes the state change at a certain time point may be determined based on change degrees of a plurality of motion features. As a plurality of motion features are taken into consideration, a combined and more comprehensive determination may be made as compared to the determination based on a single motion feature, improving the accuracy and adaptability of the determination. Besides, the change degrees of a plurality of motion features, instead of instantaneous values of a motion feature, are taken into consideration, leading to less dependency of the determination on environment, further improving the accuracy and adaptability of the determination.

In addition, the techniques described herein can not only be used alone to achieve motion detection, but also be used as input for existing methods for motion recognition (that is, methods for identifying what specific motion the object is performing, for example, whether the object is walking, falling or standing still and so on), so that the existing methods for motion recognition may be performed based on the time points identified by the techniques described herein, improving recognition accuracy and saving computing resources of the existing methods for motion recognition.

### BRIEF DESCRIPTION OF DRAWINGS

The above and other objects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure, but do not constitute a limitation on the present disclosure. In the drawings, unless otherwise explicitly indicated, the same reference numerals refer to the same components, steps or elements.

FIG. 1 illustrates a general concept of the present disclosure;

FIG. 2 illustrates a flowchart of a method for determining a state change of an object according to an embodiment of the present disclosure;

FIG. 3 illustrates substeps of the method shown in FIG. 2 according to an embodiment of the present disclosure;

FIG. 4 is an exemplary diagram of time periods, amount of change of motion features and the change degree of motion features at a certain time point according to an embodiment of the present disclosure;

FIG. 5 illustrates a further flowchart of the method shown in FIG. 2 according to an embodiment of the present disclosure; and

FIG. 6 an exemplary block diagram illustrating a device for determining a state change of an object according to an embodiment of the present disclosure.

### DETAILED DESCRIPTION

The technical approaches of the present disclosure will be clearly and completely described below in conjunction with accompanying drawings. Obviously, the described embodiments are part of embodiments of the present disclosure, but not all of them. Based on the embodiments in the present disclosure, all other embodiments obtained by ordinary skilled in the art without making any creative efforts fall within the scope of protection of the present disclosure.

In the description of the present disclosure, it should be noted that terms such as “first”, “second” and “third” are only for descriptive purposes, whereas cannot be understood as indicating or implying relative importance. Likewise, words like “a”, “an” or “the” do not represent a quantity limit, but represent an existence of at least one. Words like “include” or “comprise” mean that an element or an object in front of said word encompasses those ones listed following the said word and their equivalents, without excluding other elements or objects.

In addition, technical features involved in different embodiments of the present disclosure described below may be combined with each other as long as no conflicts occur therebetween.

As described above, motion detection technology may include stationary and motion detection, as well as motion segmentation. Currently, some existing methods may distinguish the transition between the stationary state and the motion state of the object, but cannot distinguish the transition between different modes of motions, such as changing from walking to jumping and from standing up to falling; on the other hand, some existing methods may distinguish the transition between different modes of motions, but with a high computing complexity, and may not distinguish the transition between the stationary state and the motion state effectively. In addition, some existing methods determine the state change based on comparison of an instantaneous value of a characteristic of a channel and a threshold, resulting the determination greatly influenced by the environment.

In view of the above problems, the present disclosure provides method, device and a computer program product for determining a state change of an object. The state referred to herein includes the stationary state and the motion state, and the motion state may be further divided into various modes of motions such as walking, jumping, squatting, standing up, falling and so on. Through the techniques described herein, whether the object undergoes the state change at a certain time point may be determined based on change degrees of a plurality of motion features. As a plurality of motion features are taken into consideration, a combined and more comprehensive determination may be made as compared to the determination based on a single motion feature, improving the accuracy and adaptability of the determination. Besides, the change degrees of a plurality of motion features, instead of instantaneous values of a motion feature, are taken into consideration, leading to less dependency of the determination on environment, further improving the accuracy and adaptability of the determination.

In addition, the techniques described herein can not only be used alone to achieve motion detection, but also be used as input for existing methods for motion recognition (that is, methods for identifying what specific motion the object is performing, for example, whether the object is walking, falling or standing still and so on), so that the existing methods for motion recognition may be performed based on the time points identified by the techniques described herein, improving recognition accuracy and saving computing resources of the existing methods for motion recognition.

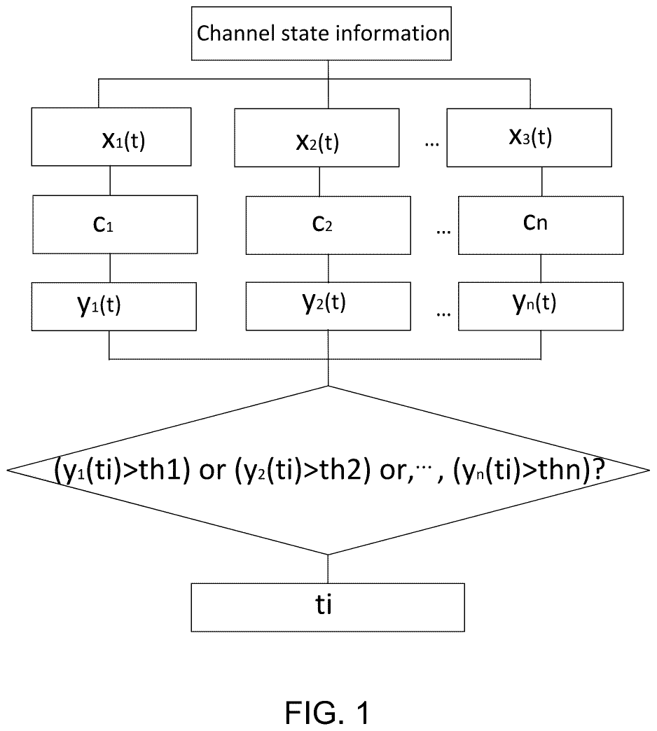

The following descriptions will be made with reference to FIG. 1. FIG. 1 illustrates a general concept of the present disclosure. As may be seen, the method, device and computer program product for determining a state change of an object according to an embodiment of the present disclosure utilize the channel state information to obtain a plurality of motion features c₁, c₂, . . . , and cₙ. The channel state information referred to herein may be 4-dimensional data, and each of the plurality of motion features c₁, c₂, . . . , and cₙ obtained from the channel state information may indicate an influence of an object on one or more wireless channels. Specifically, the 4-dimensional channel state information may be preprocessed to 1-dimensional data x₁(t), x₂(t), . . . , and xₙ(t) that changes over time, for example, through antenna selection and subcarrier selection, and the plurality of motion features c₁, c₂, . . . , and cₙ may be derived from the 1-dimensional data x₁(t), x₂(t), . . . , and xₙ(t). Once the plurality of motion features c₁, c₂, . . . , and cₙ are obtained, change degrees of the plurality of motion features over time, that is, y₁(t), y₂(t), . . . , and yₙ(t) may be obtained. The present disclosure proposes to make a joint determination on whether the object changes his/her state based on each of the change degrees y₁(t), y₂(t), . . . , and yₙ(t). As a simple approach, if any one of the change degrees y₁(t), y₂(t), . . . , and yₙ(t) is greater than its corresponding threshold (th1, th2, . . . thn) at a certain time point ti, then the time point ti is determined to be the time point at which the object changes his/her state.

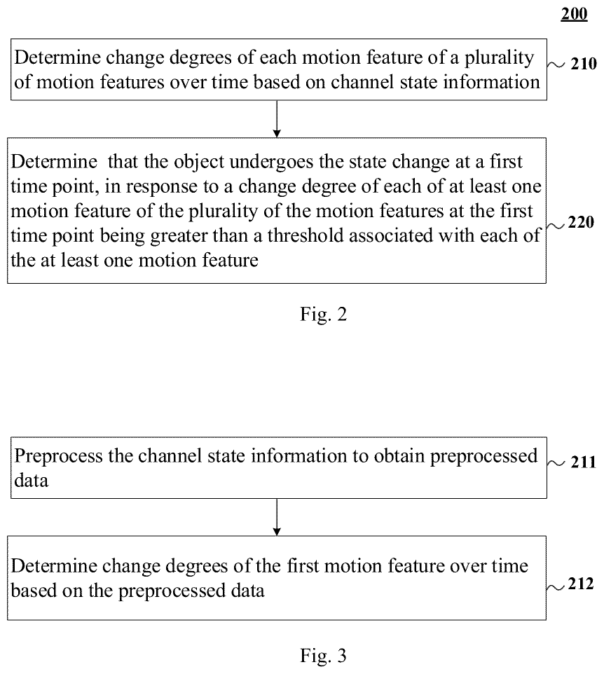

Referring now to FIG. 2. It is shown a flowchart of a method 200 for determining a state change of an object according to an embodiment of the present disclosure. The method 200 in FIG. 2 may be performed by a processor.

At step 210, change degrees of each motion feature of a plurality of motion features over time may be determined based on channel state information (CSI). The CSI may be related to one or more wireless channels, and may describe how a wireless signal propagates from a transmitter to a receiver, representing the combined effect of, for example, scattering, fading, and power decay within the space between the transmitter and receiver. In some embodiments, each of the plurality of motion features can indicate an influence of the object on one or more wireless channels, and thus whether the object undergoes the state change may be reflected on the change degrees of motion features.

The channel state information may be extracted or obtained from Wi-Fi signals using any known methods. Most public places and families have deployed Wi-Fi networks, therefore Wi-Fi signals are easy to be obtained and there is no need for additional deployment, which reduces the cost. The sensing process based on Wi-Fi signals can realize non-contact and non-invasive monitoring of the object and will not collect sensitive information such as voice, image and video of the object, thus avoiding the risk of personal privacy disclosure. Therefore, in some embodiments, the channel state information may be obtained from Wi-Fi signals, so that it is possible to reduce the cost for detecting the state change of the object and to reduce the influence on the object whose state is monitored through the techniques described herein.

The channel state information extracted or obtained from Wi-Fi signals may be 4-dimensional data denoted as H(m, n, k, t), where m represents the transmitting antenna number, n represents receiving antenna number, k represents the subcarrier number, and t represents discrete time number. H(m, n, k, t) is a complex number, representing the sampled value (at discrete time points) of the CFR (channel frequency response) on the k-th subcarrier between the m-th transmitting antenna and the n-th receiving antenna.

In some embodiments, in order to obtain the plurality of motion features so as to determine the change degrees of each of the plurality of motion features, the channel state information may be preprocessed according to any known methods to reduce down to various kinds of one-dimensional data x₁(t), x₂(t), . . . , and xₙ(t) that each changes over time, and the one-dimensional data x₁(t), x₂(t), . . . , and xₙ(t), referred to herein as preprocessed data, may be further used to determine the respective motion features c₁, c₂, . . . , and cₙ. That is to say, for any one of the plurality of motion features, the step 210 can include 2 substeps of 211 and 212, as shown in FIG. 3.

At substep 211, the channel state information may be preprocessed to obtain preprocessed data, the preprocessing referred to herein can include at least one of a noise reduction, an outlier elimination, a data calibration, an antenna selection or a subcarrier selection. The noise reduction, outlier elimination and data calibration may be included in the preprocessing, which may reduce the influence of noise on subsequent determination, improve efficiency for subsequent data processing, reduce computational burden, and improve the accuracy of subsequent determination of the state change of the object. The preprocessing can also include for example antenna selection or subcarrier selection, so as to select out signal components that change most significantly during the state change of the object, and therefore the change degrees of the motion features determined based on the signal components are also significantly and easily to be identified. One example of obtaining one-dimensional data from four-dimensional channel state information is to simply select the parameters of m, n and k in channel state information H(m, n, k, t). For example, H(2, 3, 5, t) is one-dimensional data that represents the CSI corresponding to a plurality of frames (corresponding to discrete time t) on the fifth subcarrier transmitted between the second transmitting antenna and the third receiving antenna. H(2, 3, 5, t) may be further processed to a motion feature that reflects an influence of the object on one or more channels between the second transmitting antenna and the third receiving antenna. The above mentioned preprocessing such as noise reduction, outlier elimination and data calibration may be performed before or after obtaining H(2, 3, 5, t), and before obtaining the motion feature. In another example, parameters of m and n may be firstly selected, and parameter k may be selected later based on values of H(2, 3, k, t), with the subcarrier that changes most significantly being selected. The above examples are only provided to describe exemplary ways to obtain the one-dimensional preprocessed data x₁(t), x₂(t), . . . , or xₙ(t) from the channel state information, it will be appreciated that there are other ways to obtain the one-dimensional preprocessed data, and the present disclosure is not limited thereto and is intended to encompass all the possible ways.

The preprocessing may be common with respect to all of the plurality of motion features, or dedicated preprocessing may be performed with respect to certain motion features. For example, data calibration may be a common preprocessing, the channel state information may need to be calibrated firstly before obtaining any motion feature or change degree thereof. For another example, for motion features such as spectrum information, the preprocessing of time-to-frequency transformation may be needed.

At substep 212, change degrees of a first motion feature of the plurality of motion features over time may be determined based on the preprocessed data. The first motion feature herein refers to any one of the plurality of motion features c₁, c₂, . . . , and cₙ. That is, through substep 211, one of the preprocessed data x₁(t), x₂(t), . . . , or xₙ(t) is obtained, and through substep 212, change degrees of one of the motion features c₁, c₂, . . . , or cₙ may be determined correspondingly based on the preprocessed data obtained at substep 211.

As described above, a motion feature can indicate an influence of the object on one or more wireless channels. In some embodiments, a motion feature may be statistical data of phase data or amplitude data derived from the preprocessed data. The preprocessed data is related to a subcarrier, and contains phase data and amplitude data for the subcarrier. Therefore, phase data and amplitude data may be directly derived or extracted from the preprocessed data. Any motion feature may be calculated as statistical data of the derived phase data or the derived amplitude data, for example, a variance or standard deviation of the derived phase data or derived amplitude data. In some embodiments, a motion feature may be spectrum information derived from the preprocessed data. For example, Short Time Fourier Transform (STFT) or Wavelet Transform may be applied to extract the spectrum information. In some embodiments, the spectrum information may refer to Doppler spectrum information, including for example dominant frequency information, frequency component information and frequency variation trend information.

Each of the plurality of motion features may indicate an influence of the object on one or more wireless channels, and each motion feature may be sensitive to different state changes of the object. For example, the statistical data of phase data or amplitude data may be sensitive to state changes of a transition from a stationary state to a motion state or a transition from the motion state to the stationary state, which means that the change extent or variation degree of the statistical data of phase data or amplitude data will be significant at a time point where the transition from the stationary state to the motion state or the transition from the motion state to the stationary state occurs. On the other hand, the statistical data of phase data or amplitude data may be not so sensitive to state changes of the transition from a first mode of motion to a second mode of motion, for example, a transition from walking to falling. However, the spectrum information may be sensitive to state changes of the transition from the first mode of motion to the second mode of motion, and thus may be used to identify the time point where that transition occurs. Through utilizing the plurality of motion features, a combined and more comprehensive determination on the state changes may be made as compared to the determination based on a single motion feature, improving the accuracy and adaptability of the determination.

Once the plurality of motion features c₁, c₂, . . . , and cₙ are obtained, change degrees of the plurality of motion features over time, that is, y₁(t), y₂(t), . . . , and yₙ(t) may be obtained.

In some embodiments, the change degree of a certain motion feature at each time point may include an amount of change of the motion feature between two time periods before and after each time point. Taking two motion features as an example, the change degree of a first motion feature of the plurality of motion features at each time point may include a first amount of change of the first motion feature between a first time period before and a second time period after each time point, while the change degree of a second motion feature of the plurality of motion features at each time point may include a second amount of change of the second motion feature between a third time period before and a fourth time period after each time point. It may be appreciated that the amount of change of a certain motion feature is also data that varies over time.

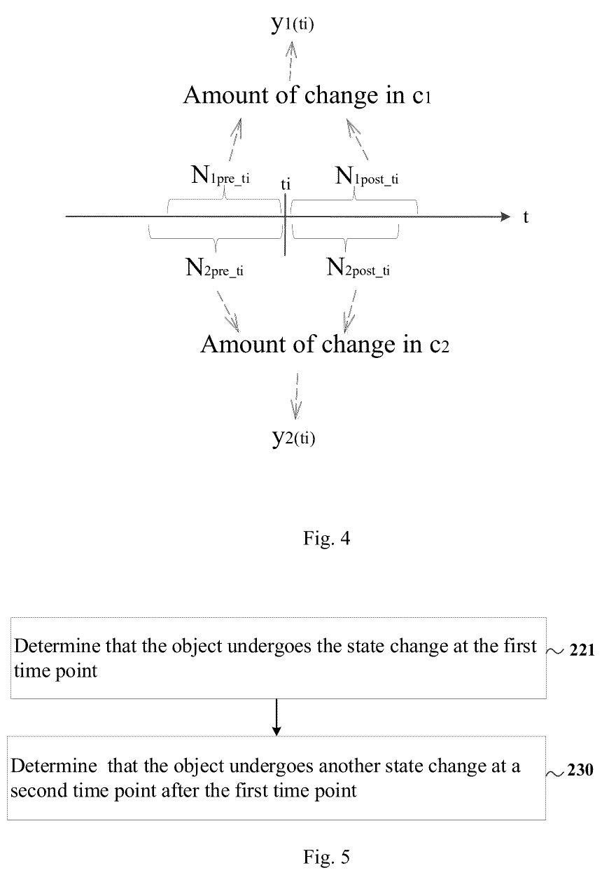

FIG. 4 is an exemplary diagram of time periods, amount of change of motion features and the change degree of motion features at a certain time point according to an embodiment of the present disclosure. In FIG. 4, two motion features, namely a first motion feature c₁ and a second motion feature c₂, are used for illumination. It may be appreciated that the first and second motion features referred to herein may be any motion feature in the plurality of motion features, and the description related to motion features c₁ and c₂ in FIG. 4 may be applied to all of the plurality of motion features.

As may be seen from FIG. 4, at a certain time point ti, which represents any time point in the time axis, a first time period before time point ti is denoted as N_{1pre_ti}, and a second time period after the time point ti is denoted as N_{1post_ti} for the first motion feature c₁. Likewise, a third time period before time point ti is denoted as N_{2pre_ti}, and a fourth time period after the time point ti is denoted as N_{2post_ti} for the second motion feature c₂.

Change degrees y₁(t) of the first motion feature c₁ at each time point ti may include a first amount of change of the first motion feature c₁ between the first time period N_{1pre_ti} before and the second time period N_{1post_ti} after each time point ti, while change degrees y₂(t) of the second motion feature c₂ at each time point ti may include a second amount of change of the second motion feature c₂ between the third time period N_{2pre_ti} before and the fourth time period N_{2post_ti} after each time point ti. Taking the first motion feature c₁ being a variance of phase data or amplitude data derived from preprocessed data x₁(t) for an example, the amount of change of the first motion feature c₁ at the time point ti may be calculated as a difference of a variance of the phase data or amplitude data in the first time period N_{1pre_ti} and a variance of the phase data or amplitude data in the second time period N_{1post_ti}. Taking the second motion feature c₂ being a dominant frequency in spectrum information for another example, the amount of change of the second motion feature c₂ at the time point ti may be calculated as a difference of a dominant frequency in the third time period N_{2pre_ti} and a dominant frequency in the fourth time period N_{2post_ti}.

In some embodiments, the amount of change of a motion feature at a certain time point may be calculated as an absolute value of the difference of the motion feature between time periods before and after the time point, or be calculated as a ratio of a value of the motion feature in the time period before the time point to and a value of the motion feature in the time period after the time point. Continuing with the above example related to the first motion feature c₁ being a variance of phase data or amplitude data, the amount of change of the first motion feature c₁ at the time point ti may be calculated as an absolute value of the difference between the variance Vpre(ti) and the variance Vpost(ti), that is, |Vpre(ti)−Vpost(ti)|, or calculated as a ratio of Vpre(ti) to Vpost(ti), that is,

$$\frac{Vpre ( ti )}{Vpost ( t i )} ,$$

wherein Vpre(ti) indicates a variance of the phase data or amplitude data in the first time period N_{1pre_ti}, and Vpost(ti) indicates a variance of the phase data or amplitude data in the second time period N_{1post_ti}. The change degree at each time point may include the corresponding amount of change, for example, the change degree may be set to be equal to the corresponding amount of change.

In some embodiments, the time period before a certain time point and the time period after the time point for one motion feature may be the same or different in duration. Moreover, at the same time point, the time periods before the time point for different motion features may also be the same or different in duration, and the time periods after the time point for different motion features may also be the same or different in duration. That is, each two of the first time period, the second time period, the third time period and the fourth time period are the same or different from each other. Still referring to FIG. 4, the first time period N_{1pre_ti} and the second time period N_{1post_ti} may be the same or different in duration, the third time period N_{2pre_ti} and the fourth time period N_{2post_ti} may be the same or different in duration, the first time period N_{1pre_ti} and the third time period N_{2pre_ti} may be the same or different in duration, the second time period N_{1post_ti} and the fourth time period N_{2post_ti} may be the same or different in duration, and so on.

Referring back to FIG. 2, at step 220, it may be determined that the object undergoes the state change at a first time point, in response to a change degree of each of at least one motion feature of the plurality of motion features at the first time point being greater than a threshold associated with each of the at least one motion feature. Since the change degrees of each motion feature over time is already determined at step 210, the change degree of each motion feature at each time point may be determined. The present disclosure proposes to make the determination that the object undergoes the state change at a certain time point if the change degree of any motion feature at that time point is greater than a corresponding threshold for that motion feature. There are cases when a state change of the object actually occurs, but the change may not be observed through the change degree of a certain motion feature. For example, considering a case where a person is walking and suddenly falls down at a first time point, that is, the state of the person changes from walking to falling at that first time point. This change may not greatly influence the change degree of the motion feature of phase, but may greatly influence the change degree of the motion feature of spectrum, which means that the change degree of the motion feature of spectrum at that first time point will be greater than its corresponding threshold. In this case, through the techniques of the present disclosure, since at least one motion feature (that is, the spectrum) at the first time point is greater than the threshold associated with each of the at least one motion feature, it may be determined that the object (that is, the person) undergoes the state change at the first time point. Therefore, through the techniques described herein, a combined and more comprehensive determination may be made, improving the accuracy and adaptability of the determination.

As described above, the change degree of a certain motion feature at each time point may include an amount of change of the motion feature between two time periods before and after each time point. In this case, taking the above example with two motion features c₁(t) and c₂(t), step 220 may include determining that the object undergoes the state change at the first time point ti, in response to at least one of the following: (1) the first amount of change of the first motion feature c₁ being greater than a first threshold th1 at the first time point ti; and (2) the second amount of change of the second motion feature c₂ being greater than a second threshold th2 at the first time point ti. That is, either or both of the first amount of change and the second amount of change at the first time point ti being greater than their corresponding thresholds will result in the determination that the object undergoes the state change at the first time point ti. The first threshold th1 and the second threshold th2 may be thresholds preset for the corresponding motion features c₁ and c₂. Although two motion features are described herein as an example, it should be appreciated that the above description may be applied to more than two motion features. Therefore, through the techniques described herein, a combined and more comprehensive determination may be made, improving the accuracy and adaptability of the determination.

The combined and comprehensive determination of the state change of the object may not only involve the parallel determination as described above, but also involve serial determination. There are cases where another state change is likely to occur after the occurrence of a first state change. For example, the first state change may be a transition from a stationary state to a motion state, then a transition from a first mode of motion to a second mode of motion is likely to occur. For example, a person changes from sitting still to standing up, then the person is more likely to change from standing up to walking or falling, but not likely to change again from sitting still to standing up. For another example, a person changes from not existing in the environment to walking in the environment, then the person is more likely to change from walking to running or falling, but not likely to change again from not existing to walking. In this case, the latter state change may be determined or detected based on the occurrence of the former state change, and the same kind of former state change may no longer be monitored for subsequent time periods.

FIG. 5 illustrates a further flowchart of the method 200 in FIG. 2 according to an embodiment of the present disclosure. As may be seen, step 220 in FIG. 2 may include a substep 221. At substep 221, it may be determined that the object undergoes the state change at the first time point, in response to the change degree of a first motion feature of the plurality of motion features at a first time point being greater than a threshold associated with the first motion feature. That is, at substep 221, the determination that the object undergoes the state change at the first time point is based on the change degree of the first motion feature at the first time point. Then, the method 200 may include a further step 230 after substep 221, where it may be determined that the object undergoes another state change at a second time point after the first time point, in response to change degrees of one or more motion features of the plurality of motion features other than the first motion feature at the second time point being greater than one or more thresholds associated with the one or more motion features. That is, after the first time point, the change degrees of the first motion feature over time are no longer monitored or computed, and the method may focus on change degrees of motion features other than the first motion feature to make the further determination on whether another state change occurs to the object at a time point after the first time point. In this way, less computation is needed for the time periods after the first time point, and computational overhead and the performance of motion detection may be balanced.

In some embodiments, the state change mentioned herein may include a transition from a stationary state to a motion state, a transition from the motion state to the stationary state, or a transition from a first mode of motion to a second mode of motion, such as a transition from walking to jumping, from running to falling, or from standing up to walking. As a plurality of motion features are taken into consideration in the techniques for determining a state change of an object according to embodiments of the present disclosure, various kinds of state changes may be determined or detected, including transitions between the stationary state and the motion state, as well as transitions between different modes of motions.

According to embodiments of the present disclosure, whether the object undergoes the state change at a certain time point may be determined based on change degrees of a plurality of motion features jointly. As a plurality of motion features are taken into consideration, a combined and more comprehensive determination may be made as compared to the determination based on a single motion feature, improving the accuracy and adaptability of the determination. Besides, the change degrees of a plurality of motion features, instead of instantaneous values of a motion feature, are taken into consideration, leading to less dependency of the determination on environment, further improving the accuracy and adaptability of the determination.

In addition, the techniques described herein may be used alone to achieve motion detection, and also be used as input for existing methods for motion recognition (that is, methods for identifying what specific motion the object is performing, for example, whether the object is walking, falling or standing still and so on), so that the existing methods for motion recognition may be performed based on the time points identified by the techniques described herein, improving recognition accuracy and saving computing resources of the existing methods for motion recognition.

The methods according to embodiments of the present disclosure may be performed by a processor/device that may process channel state information or process Wi-Fi signals to obtain channel state information, the processor/device may be external to or incorporated in a Wi-Fi apparatus.

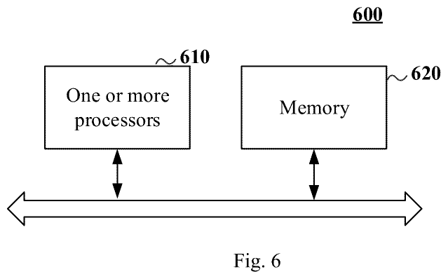

FIG. 6 is an exemplary block diagram illustrating a device 600 for determining a state change of an object according to an embodiment of the present disclosure. It should be noted that the device 600 depicted in FIG. 6 may be used to perform the operations of determining a state change of an object, for example, the method 200 as described above.

As shown in FIG. 6, the device 600 comprises one or more processors 601 and a memory 602. The one or more processors 601 are communicatively coupled with the memory 602 and configured to perform the methods discussed above.

Examples of the one or more processors 601 comprise microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The one or more processors 601 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on memory 602.

The memory 602 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The memory 602 may reside in the one or more processors 601, external to the one or more processors 601, or distributed across multiple entities including the one or more processors 601. The memory 602 may be embodied in a computer program product. By way of example, a computer program product may include a computer-readable medium in packaging materials. Those skilled in the art will recognize how to implement the described functionality presented throughout this disclosure depending on the particular application and the overall design constraints imposed on the overall system.

In addition, according to another embodiment of the present disclosure, a computer program product for determining a state change of an object is disclosed. As an example, the computer program product comprises a non-transitory computer readable storage medium having program instructions embodied therewith, and the program instructions are executable by a processor. In response to being executed, the program instructions cause the processor to perform one or more of the described procedures above, and details are omitted herein for conciseness.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

Expression such as “according to”, “based on”, “dependent on”, and so on as used in the disclosure does not mean “according only to”, “based only on”, or “dependent only on”, unless it is explicitly otherwise stated. In other words, such expression generally means “according at least to”, “based at least on”, or “dependent at least on” in the disclosure.

Any reference in the disclosure to an element using the designation “first”, “second” and so forth is not intended to comprehensively limit the number or order of such elements. These expressions may be used in the disclosure as a convenient method for distinguishing two or more units. Thus, a reference to a first unit and a second unit does not imply that only two units may be employed or that the first unit must precede the second unit in some form.

The term “determining” used in the disclosure may include various operations. For example, regarding “determining”, calculating, computing, processing, deriving, investigating, looking up (e.g., looking up in tables, databases, or other data structure), ascertaining, and so forth are regarded as “determination”. In addition, regarding “determining”, receiving (for example, receiving information), transmitting (for example, transmitting information), input, output, accessing (for example, access to data in the memory), and so forth, are also regarded as “determining”. In addition, regarding “determining”, resolving, selecting, choosing, establishing, comparing, and so forth may also be regarded as “determining”. That is, regarding “determining”, several actions may be regarded as “determining”.

The terms such as “connected”, “coupled” or any of their variants used in the disclosure refer to any connection or combination, direct or indirect, between two or more units, which may include the following situations: between two units that are “connected” or “coupled” with each other, there are one or more intermediate units. The coupling or connection between the units may be physical or logical, or may also be a combination of the two. As used in the disclosure, two units may be considered to be electrically connected through the use of one or more wires, cables, and/or printed, and as a number of non-limiting and non-exhaustive examples, and are “connected” or “coupled” with each other through the use of electromagnetic energy with wavelengths in a radio frequency region, the microwave region, and/or in the light (both visible and invisible) region, and so forth.

When used in the disclosure or the claims “including”, “comprising”, and variations thereof, these terms are as open-ended as the term “having”. Further, the term “or” used in the disclosure or in the claims is not an exclusive-or.

The present disclosure has been described in detail above, but it is obvious to those skilled in the art that the present disclosure is not limited to the embodiments described in the disclosure. The present disclosure may be implemented as a modified and changed form without departing from the spirit and scope of the present disclosure defined by the description of the claims. Therefore, the description in the disclosure is for illustration and does not have any limiting meaning to the present disclosure.

What is claimed is:

1. A method for determining a state change of an object, comprising:
determining change degrees of each motion feature of a plurality of motion features over time based on channel state information; and
determining that the object undergoes the state change at a first time point, in response to a change degree of each of at least one motion feature of the plurality of the motion features at the first time point being greater than a threshold associated with each of the at least one motion feature.

2. The method of claim 1, wherein each of the plurality of the motion features indicates an influence of the object on one or more wireless channels.

3. The method of claim 1, wherein the determining the change degrees of each motion feature of the plurality of the motion features over time based on the channel state information comprises, for a first motion feature among the plurality of the motion features:
preprocessing the channel state information to obtain preprocessed data, wherein the preprocessing comprises at least one of a noise reduction, an outlier elimination, a data calibration, an antenna selection or a subcarrier selection; and
determining change degrees of the first motion feature over time based on the preprocessed data.

4. The method of claim 3, wherein the first motion feature comprises one of:
statistical data of phase data derived from the preprocessed data;
statistical data of amplitude data derived from the preprocessed data; and
spectrum information derived from the preprocessed data.

5. The method of claim 1, wherein
a change degree of a first motion feature of the plurality of the motion features at a time point comprises a first amount of change of the first motion feature between a first time period before and a second time period after the time point; and
a change degree of a second motion feature of the plurality of the motion features at the time point comprises a second amount of change of the second motion feature between a third time period before and a fourth time period after the time point;
wherein each two of the first time period, the second time period, the third time period and the fourth time period are the same or different from each other in duration.

6. The method of claim 1, wherein the determining that the object undergoes the state change at the first time point, in response to the change degree of each of the at least one motion feature of the plurality of the motion features at the first time point being greater than the threshold associated with each of the at least one motion feature, comprises:
determining that the object undergoes the state change at the first time point, in response to the change degree of a first motion feature of the plurality of the motion features at the first time point being greater than a threshold associated with the first motion feature,
and wherein the method further comprising, in response to determining that the object undergoes the state change:
determining that the object undergoes another state change at a second time point after the first time point, in response to change degrees of one or more motion features of the plurality of the motion features other than the first motion feature at the second time point being greater than one or more thresholds associated with the one or more motion features.

7. The method of claim 1, wherein the state change comprises a transition from a stationary state to a motion state, a transition from the motion state to the stationary state, or a transition from a first mode of motion to a second mode of motion.

8. The method of claim 1, wherein the channel state information is obtained from Wi-Fi signals.

9. A device for determining a state change of an object, comprising:
one or more processors;
a memory coupled to at least one of the one or more processors; and
a set of computer program instructions stored in the memory, in response to being executed by at least one of the one or more processors, perform actions of:
determining change degrees of each motion feature of a plurality of motion features over time based on channel state information; and
determining that the object undergoes the state change at a first time point, in response to a change degree of each of at least one motion feature of the plurality of the motion features at the first time point being greater than a threshold associated with each of the at least one motion feature.

10. The device of claim 9, wherein each of the plurality of the motion features indicates an influence of the object on one or more wireless channels.

11. The device of claim 9, wherein the determining the change degrees of each motion feature of the plurality of the motion features over time based on the channel state information, comprises, for a first motion feature among the plurality of the motion features:
preprocessing the channel state information to obtain preprocessed data, wherein the preprocessing comprises at least one of a noise reduction, an outlier elimination, a data calibration, an antenna selection or a subcarrier selection; and
determining change degrees of the first motion feature over time based on the preprocessed data.

12. The device of claim 11, wherein the first motion feature comprises one of:
statistical data of phase data derived from the preprocessed data;
statistical data of amplitude data derived from the preprocessed data; and
spectrum information derived from the preprocessed data.

13. The device of claim 9, wherein
a change degree of a first motion feature of the plurality of the motion features at a time point comprises a first amount of change of the first motion feature between a first time period before and a second time period after the time point; and
a change degree of a second motion feature of the plurality of the motion features at the time point comprises a second amount of change of the second motion feature between a third time period before and a fourth time period after the time point,
wherein each two of the first time period, the second time period, the third time period and the fourth time period are the same or different from each other in duration.

14. The device of claim 9, wherein the determining that the object undergoes the state change at the first time point, in response to the change degree of each of the at least one motion feature of the plurality of the motion features at the first time point being greater than the threshold associated with each of the at least one motion feature, comprises:
determining that the object undergoes the state change at the first time point, in response to the change degree of a first motion feature of the plurality of the motion features at the first time point being greater than a threshold associated with the first motion feature,
and wherein the set of computer program instructions, in response to being executed by at least one of the one or more processors, further perform actions of, in response to determining that the object undergoes the state change:
determining that the object undergoes another state change at a second time point after the first time point, in response to change degrees of one or more motion features of the plurality of the motion features other than the first motion feature at the second time point being greater than one or more thresholds associated with the one or more motion features.

15. The device of claim 9, wherein the state change comprises a transition from a stationary state to a motion state, a transition from the motion state to the stationary state, or a transition from a first mode of motion to a second mode of motion.

16. The device of claim 9, wherein the channel state information is obtained from Wi-Fi signals.

17. A computer program product for determining a state change of an object, the computer program product comprising a non-transitory computer readable storage medium having program instructions embodied therewith, the program instructions, in response to being executed by a processor, cause the processor to:
determine change degrees of each motion feature of a plurality of motion features over time based on channel state information; and
determine that the object undergoes the state change at a first time point, in response to a change degree of each of at least one motion feature of the plurality of the motion features at the first time point being greater than a threshold associated with each of the at least one motion feature.

18. The computer program product of claim 17, wherein the determining that the object undergoes the state change at the first time point, in response to the change degree of each of the at least one motion feature of the plurality of the motion features at the first time point being greater than the threshold associated with each of the at least one motion feature, comprises:
determining that the object undergoes the state change at the first time point, in response to the change degree of a first motion feature of the plurality of the motion features at the first time point being greater than a threshold associated with the first motion feature,
and wherein the program instructions, in response to being executed by a processor, further cause the processor to, in response to determining that the object undergoes the state change:
determine that the object undergoes another state change at a second time point after the first time point, in response to change degrees of one or more motion features of the plurality of the motion features other than the first motion feature at the second time point being greater than one or more thresholds associated with the one or more motion features.

19. The computer program product of claim 17, wherein the state change comprises a transition from a stationary state to a motion state, a transition from the motion state to the stationary state, or a transition from a first mode of motion to a second mode of motion.

20. The computer program product of claim 17, wherein the channel state information is obtained from Wi-Fi signals.
